(19) United States
(12) Patent Application Publication
(10) Pub. No.: US 2008/0255852 A1
(43) Pub. Date: Oct. 16, 2008

(54) APPARATUSES AND METHODS FOR VOICE COMMAND PROCESSING

(75) Inventor: Chih-Lin Hu, Taipei City (TW)

Correspondence Address: QUINTERO LAW OFFICE, PC, 2210 MAIN STREET, SUITE 200, SANTA MONICA, CA, 90405, US

(73) Assignee: QISDA CORPORATION, TAOYUAN COUNTY (TW)

(21) Appl. No.: 11/952,971

(22) Filed: Dec. 7, 2007

(30) Foreign Application Priority Data
Apr. 13, 2007 (TW) TW96113004

(51) Int. Cl. G10L 21/00

(52) U.S. Cl. 704/275

(57) ABSTRACT

An apparatus for voice command processing comprising a mobile agent execution platform is provided. The mobile agent execution platform comprises a native platform, at least one agent, a mobile agent execution context, and a mobile agent management unit. The mobile agent execution context provides an application interface, enabling the agent to access resources of the native platform via the application interface. The mobile agent management unit performs initiation, running, suspension, resumption and dispatch of the agent. The agent performs functions regarding voice command processing.

### BACKGROUND

The invention relates to speech/voice recognition, and more particularly, to apparatuses and methods for voice command processing.

Speech (or voice) recognition is recognized as a user-friendly man-machine-interface (MMI) facility. Speech recognition has manifested functionality in terms of resolving meaning of spoken language

### SUMMARY

An embodiment of an apparatus for voice command processing comprising a mobile agent execution platform, is provided. The mobile agent execution platform comprises a native platform, at least one agent, a mobile agent execution context, and a mobile agent management unit. The mobile agent execution context provides an application interface, enabling the agent to access resource of the native platform via the application interface. The mobile agent management unit performs initiation, running, suspension, resumption and dispatch of the agent. The agent performs functions regarding voice command processing.

An embodiment of a method for voice command processing, performed by an electronic device equipped with a microphone, comprises the following steps. A speech recognition agent comprising a computer program performing speech recognition, an acoustics model, a lexicon, and a language model is received. The speech recognition agent is a clone of a speech recognition agent of a target device. A syntax of at least one voice word is acquired according to the syntax model, and a statement expression is generated by interpreting the acquired syntax according to the semantics model by using the language interpretation agent.

An embodiment of an electronic device comprises an input device, a voice command controller, and an authentication code. The voice command controller recognizes the raw voice data, and comprises a speech recognition agent, a language interpretation agent, and an interpretive representation agent. When the electronic device connects to a remote device, the voice command controller selectively refreshes the speech recognition agent, the language interpretation agent, and the interpretive representation agent according to the authentication code.

### BRIEF DESCRIPTION OF DRAWINGS

The invention will become more fully interpreted by referring to the following detailed description with reference to the accompanying drawings, wherein:

FIG. 1 is a diagram of network architecture of an embodiment of a voice command processing system;

FIG. 2 is a diagram of a hardware environment applicable to an embodiment of a mobile phone;

FIG. 3 is a diagram of a hardware environment applicable to an embodiment of a personal computer;

FIG. 4 is a diagram illustrating an embodiment of five phases of voice command processing;

FIG. 5 is a diagram depicting the key entities included in a speech recognition phase, a language interpretation phase, and an interpretation phase;

FIG. 6 is a flowchart illustrating a typical method for voice command processing;

FIG. 7 is a diagram of an embodiment of a mobile agent execution platform;

FIG. 8 is a diagram of voice command service;

FIGS. 9A to 9D are diagrams illustrating embodiments of agent delegation and dispatch.

### DETAILED DESCRIPTION

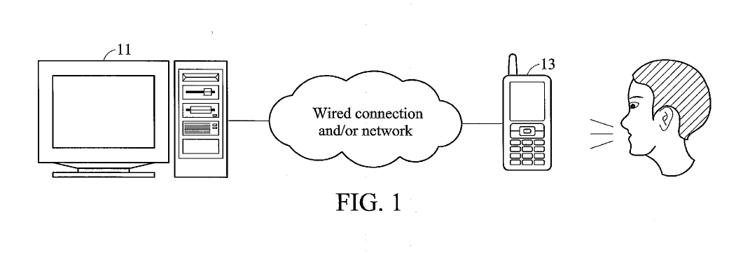

FIG. 1 is a diagram of network architecture of an embodiment of a voice command processing system, comprising a personal computer 11 and a mobile phone 13. Unlike personal computer 11, the mobile phone 13 is equipped with limited computational resources, such as a processor with lower speed, less capacity of main memory and storage space, and others. The personal computer 11 and the mobile phone 13 operate in a wired connection or network or a combination thereof, connected thereby. Those skilled in the art will recognize that the personal computer 11 and the mobile phone 13 may be connected in different types of networking environments, and may communicate therebetween through various types of transmission devices such as routers, gateways, access points, base station systems or others. The personal computer may represent a target device, and the mobile phone may represent a remote device. The mobile phone 13 is equipped with a microphone receiving voice signals from a user nearby.

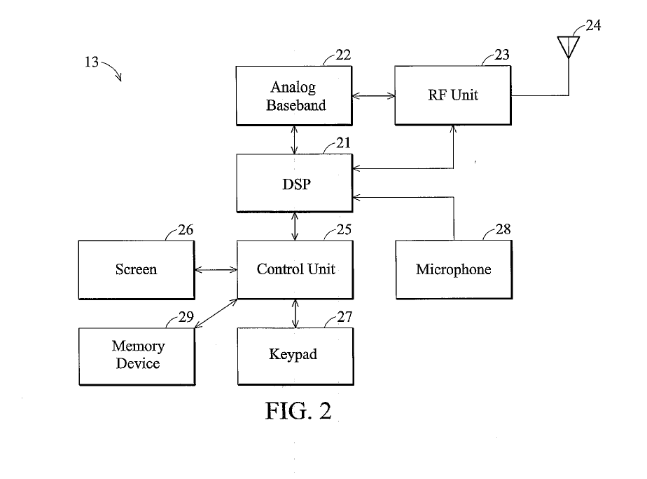

FIG. 2 is a diagram of a hardware environment applicable to an embodiment of the mobile phone 13, comprising a DSP (digital signal processor) 21, an analog baseband 22, a RF (Radio Frequency) unit 23, an antenna 24, a control unit 25, a screen 26, a keypad 27, a microphone 28, and a memory device 29. Moreover, those skilled in the art will interpret that some embodiments may be utilized with other handheld electronic devices equipped with microphones, including personal digital assistants (PDAs), digital music players, and the like. The control unit 25 may be a microprocessor (MPU) unit loading and executing application program execution methods from the memory device 29 for completing voice command processing. The memory device 29 is preferably a random access memory (RAM), but may also include read-only memory (ROM) or flash memory, storing program modules. The microphone 25 perceives voice signals from a user nearby, and transmits the perceived analog signals to the DSP 21. The DSP 21 transforms the analog signals into digital signals for further process by the control unit 25.

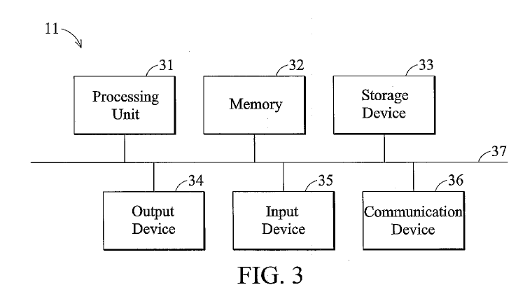

FIG. 3 is a diagram of a hardware environment applicable to an embodiment of the personal computer 11, comprising a processing unit 31, memory 32, a storage device 33, an output device 34, an input device 35 and a communication device 36. The processing unit 31 is connected by buses 37 to the memory 32, storage device 33, output device 34, input device 35 and communication device 36. Moreover, those skilled in the art will interpret that some embodiments may be applied with other computer system configurations, including multiprocessor-based, microprocessor-based or programmable consumer electronics, network PCs, minicomputers, mainframe computers, and the like. The memory 32 is preferably a random access memory (RAM), but may also include read-only memory (ROM) or flash ROM. The memory 32 preferably stores program modules executed by the processing unit 31 to perform voice command processing. Generally, program modules include routines, programs, objects, components, or others, that perform particular tasks or implement particular abstract data types. Some embodiments may also be applied in distributed computing environments where tasks are performed by remote processing devices linked through a communication network. In a distributed computing environment, program modules may be located in both local and remote memory storage devices based on various remote access architectures such as DCOM, CORBA, Web objects, Web Services or similar.

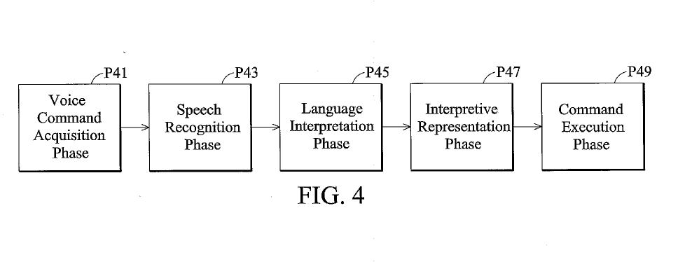

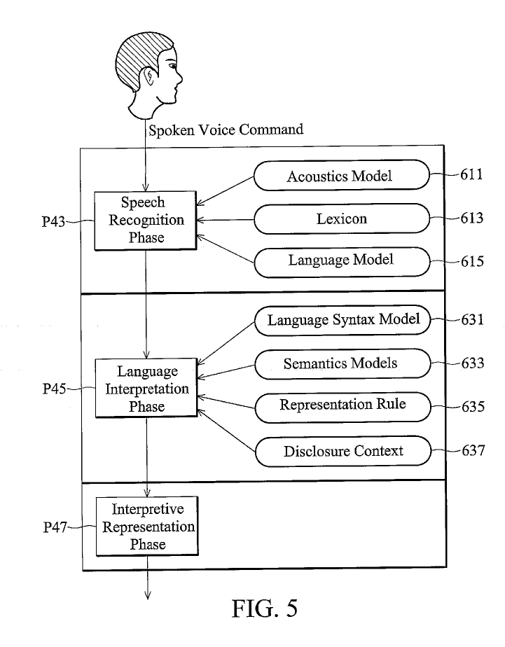

FIG. 4 is a diagram illustrating an embodiment of five phases of voice command processing, comprising voice command acquisition P41, speech recognition P43, language interpretation P45, interpretive representation P47 and command execution P49. FIG. 5 is a diagram depicting the key entities included in the speech recognition phase P43, the language interpretation phase P45, and the interpretive representation phase P47. In the voice command acquisition phase P41, a spoken voice command is intercepted and modeled as an original input of voice data, i.e. raw voice data. The raw voice data may be further manipulated, such as by data cleaning, filtering, and segmentation, before the speech recognition phase P43. In the speech recognition phase P43, the raw voice data is processed against a built-in acoustics model 611 and resultant words are generated in accordance with a language model 615 and lexicon 613. In the language representation phase P45, the syntax of the recognized voice words is acquired, and the semantics of the syntactic results are interpreted according to a built-in language syntax model 631 and semantics models 633. The result is then expressed in a proper statement expression in light of a specific representation rule 635 and disclosure context 637. After acquiring the statement expression in a certain language representation, in the interpretive representation phase P47, the acquired statement expression is interpreted as a meaning of an indicated voice command. The interpretative result is ideally mapped to a definite space of interpretive representation of voice commands. Otherwise, the interpretative result is “undefined”. In the command execution phase P49, indicated tasks corresponding to the effective voice command are executed.

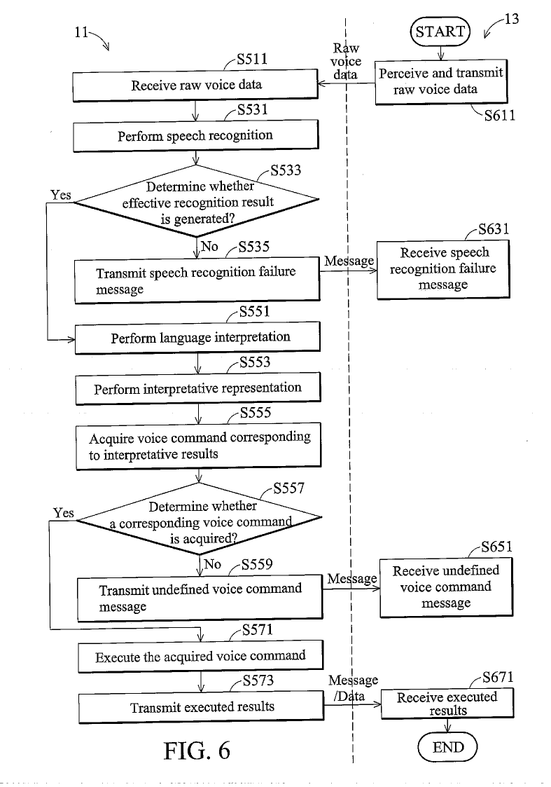

FIG. 6 is a flowchart illustrating a typical method for voice command processing, performed by the personal computer 11 and the mobile phone 13. This is not prior art for purposes of determining the patentability of the invention and merely shows a problem found by the inventors. The mobile phone 13 performs the voice command acquisition phase P41, and transmits the generated raw voice data to the personal computer 11 (step S611). After receiving the raw voice data (step S511), the personal computer performs operations of the speech recognition phase P43 (steps S531 to S535), the language interpretation phase P45 (step S551), and the interpretive representation phase P47 (steps 553 to S571). When unable to generate effective recognition result (step S533), the personal computer 11 transmits a speech recognition failure message to the mobile phone 13 (steps S535 and S631). When unable to acquire any corresponding voice commands (steps S555 and S557), the personal computer 11 transmits an undefined voice command message to the mobile phone 13 (steps S559 and S651). When acquiring a corresponding voice command (steps S555 and S559), the personal computer 11 performs the acquired voice command, and transmits the execution results or resultant data to the mobile phone 13 (steps S571, S573 and S671). The typical method comprises the following drawbacks. The transmission of raw voice data consumes excessive network bandwidth, and the mobile phone 13 requires waiting for resultant messages from the personal computer 11 to obtain final results of the speech recognition and voice command acquisition result for subsequent process, decreasing the efficiency of voice command processing.

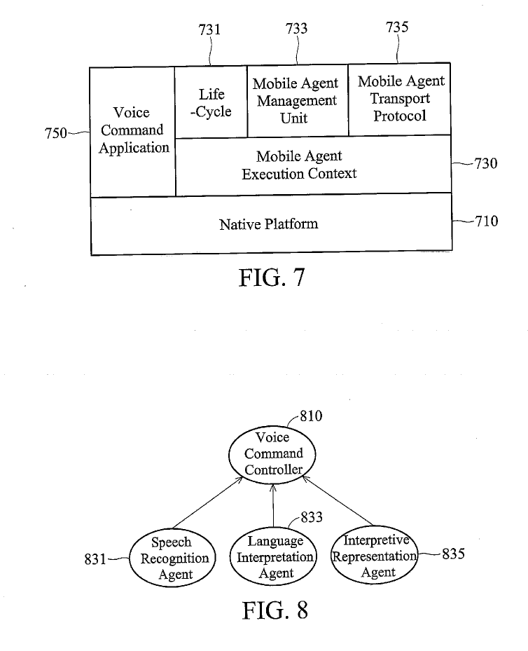

FIG. 7 is a diagram of an embodiment of a mobile agent execution platform, where an agent-based voice command controller runs for intelligent control of voice command processing. Both the personal computer 11 and the mobile phone 13 provide the mobile agent execution platforms. The mobile agent execution platform includes mobile agent execution context 730, a mobile agent transport protocol 735, and mobile agent management unit 733. The mobile agent execution context 730, an agent runtime environment, provides independent application interfaces by which a running agent is able to access resource in a native platform 710. Each agent has a deterministic life-cycle 731 corresponding to its task delegation. The mobile agent management unit 733 performs agent initiation, running, suspension, resumption and dispatch. The application-level agent transport protocol 735 is used to establish the communication tunnel between two mobile agent execution platforms in the personal computer 11 and the mobile phone 13.

FIG. 8 is a diagram of voice command service comprising a voice command controller 810, and agents 831 to 835. The voice command controller 810, also called the mobile agent management unit 733 (FIG. 7), is responsible for intercommunicating with speech recognition, language interpretation and interpretive representation agents 831 to 835. The personal computer 11 and the mobile phone 13 providing mobile agent execution platforms allows any mobile agent to run on either the computer platform (one kind of native platform), or the mobile phone platform (another kind of native platform).

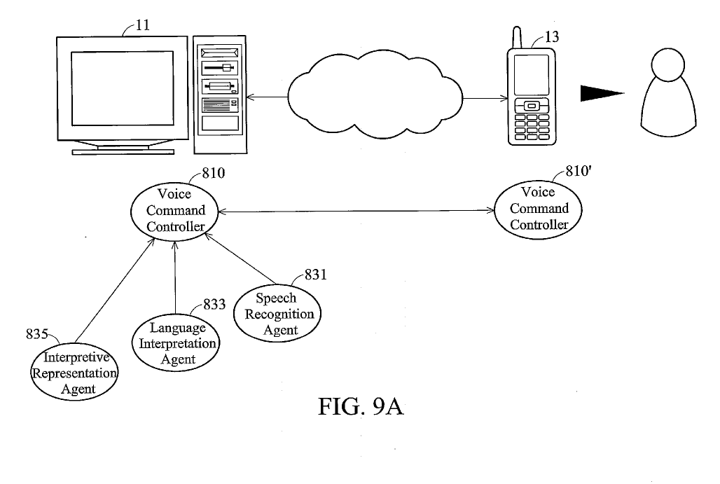

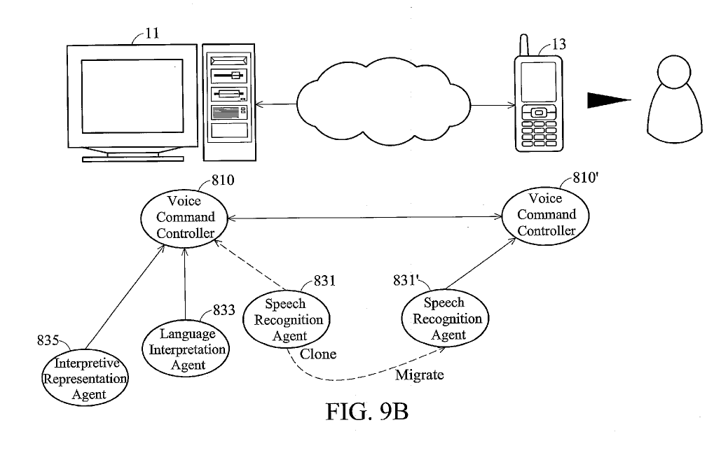

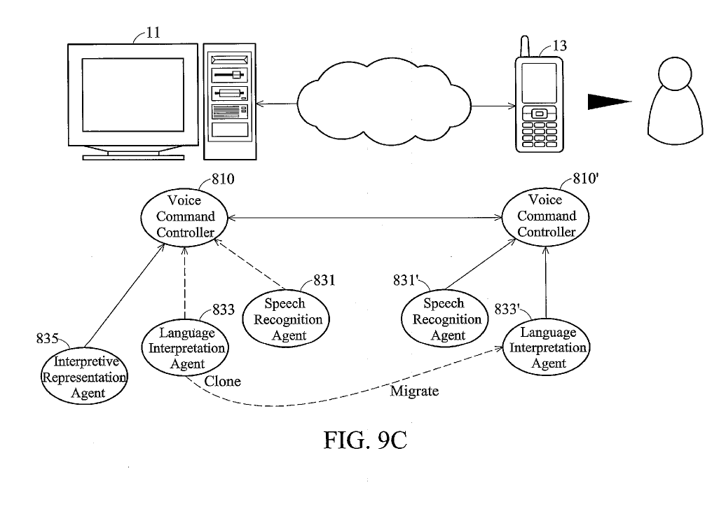

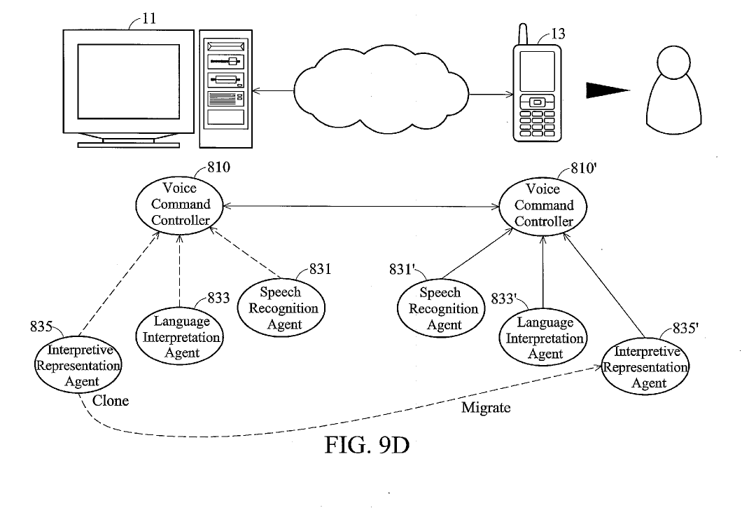

FIGS. 9A to 9D are diagrams illustrating embodiments of agent delegation and dispatch. Referring to FIG. 9A, a voice command controller 810 of the personal computer 11 may dispatch an agent to reside on a remote mobile agent execution platform of the mobile phone 13. Each agent encapsulates a delegated task (in a form of computational representation) and logic required/specified for executing the delegated task. Specifically, the voice command controller 810 may clone at least one of a speech recognition agent 831, a language interpretation agent 833, and interpretive representation agent 835 thereof, and migrate and store the cloned agents 831′, 833′, and/or 835′ in the mobile agent execution platform of the mobile phone 13. The speech recognition agent 831′ includes computational programs, algorithms of speech recognition, patterns of acoustics models, lexicons and language models, and the like, used for performing speech recognition remotely with no need to interact with the personal computer 11. Likewise, the language interpretation agent 833′ includes specific syntax and semantics models, and the rules used to determine the language to which the voice input may pertain, and the terms that may be used. The interpretive representation agent 835′ interprets the voice input, and converts the result to a voice command in a specific representation format. The resolved voice command is transmitted to the personal computer 11, and then dealt with by the voice command controller 810 of the personal computer 11. In relevant applications, those skilled in the art may utilize the voice command controller 810′ of the mobile phone 13 directly executing the resolved voice command.

Dispatch of agents is ordered corresponding to the sequential phases of the voice command process as illustrated in FIG. 5. Referring to FIG. 9B, the voice command controller 810 can dispatch the cloned speech recognition agent 831′ to reside on the mobile phone 13 to facilitate the remote voice command controller 810′. When the cloned speech recognition agent 831′ is present in the mobile phone 13, the voice command controller 810 may only refresh specific computational programs, algorithms of speech recognition, patterns of acoustics models, lexicons, or language models. When the remote voice command controller 810′ perceives voice input by a user, the speech recognition agent 810′ can deal with the voice input locally. If the agent 810′ successfully generates a recognition result, the agent 810′ transmits the result through the wired connection/network to the language interpretation agent 833 of the personal computer 11. Otherwise, if the agent 810′ fails to recognize the voice data, the remote voice command controller 810′ can generate a prompt notification. The user is immediately made aware of the situation and provides a new voice input. Furthermore, the speech recognition agent 810′ can make a better recognition result, in comparison with the speech recognition agent 810 of the personal computer 11, because the agent 831′ is near the user and is able to sense the speaking venue, surrounding context and background noise as well as avoid interference caused by network transmission. Note that the language interpretation and interpretive representation agents 833′ and 835′ can also gain the above benefits when they are running in the mobile phone 13.

Referring to FIG. 9C, after receiving the recognition result from the speech recognition agent 831′, the cloned language interpretation agent 833′ is migrated to the mobile phone 13 to cooperate with the speech recognition agent 831′. When the cloned language interpretation agent 833′ is present in the mobile phone 13, the voice command controller 810 may only refresh specific computational programs, algorithms of language interpretation, specific syntax, or semantics models. With a recognized result, the language interpretation agent 833′ assays the voice data in light of the language syntax and semantics, and tries to interpret the language expression of the voice data. Those skilled in the art will recognize that the voice command expression may not completely comply with the syntactic or semantic rules, thus, the agent 833′ can disambiguate the voice data with reference to its built-in knowledge. If the agent 831′ can successfully interpret the voice data, the generated result is transmitted to the interpretive representation agent 835 or voice command controller 810 of the personal computer 11 via the wired connection/network. If the agent 831′ cannot interpret the voice data, an unsuccessful message is reported to the remote voice command controller 831′.

Referring to FIG. 9D, after receiving the interpreted result from the language interpretation agent 833′, the cloned interpretive representation agent 835′ is migrated to the mobile phone 13 to cooperate with the vice command controller 831′. When the cloned interpretive representation agent 835′ is present in the mobile phone 13, the voice command controller 810 may only refresh specific computational programs, algorithms of interpretive representation, or voice commands. If the meaning in response to the interpreted result is defined in the voice command pools, the agent 835′ transmits the resolved voice command to the voice command controller 810 of the personal computer 11. Otherwise, the interpretive representation agent 835′ generates a notification of an undefined voice command or insolvable statement, resulting in the user being immediately notified of the situation. Those skilled in the art can realize that, before performing actual voice command processing, the personal computer 11 clones the speech recognition agent 831, the language interpretation agent 833, and the interpretive representation agent 835 of itself, and migrates the cloned agents 831′, 833′ and 835′ to reside on the mobile agent execution platform of the mobile phone 13.

Referring to FIG. 9A, the method for dispatching a voice command controller to the mobile phone 13, performed by the personal computer 11, detects the corresponding voice command controller 810 according to authentication code utilized in communication between the mobile phone 13 and personal computer 11. The authentication code may be user authentication code, subscriber identity module (SIM) card code, Internet protocol (IP) address, and the like, and be pre-stored in internal memory of the mobile phone 13. When the mobile phone 13 connects to the personal computer 11, the voice command controller 810 selectively refreshes the speech recognition agent 831′, the language interpretation agent 833′, and the interpretive representation agent 835′ according to the authentication code.

Systems and methods, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer system and the like, the machine becomes an apparatus for practicing the invention. The disclosed methods and apparatuses may also be embodied in the form of program code transmitted over some transmission medium, such as electrical wiring or cabling, through fiber optics, or via any other form of transmission, wherein, when the program code is received and loaded into and executed by a machine, such as a computer or an optical storage device, the machine becomes an apparatus for practicing the invention. When implemented on a general-purpose processor, the program code combines with the processor to provide a unique apparatus that operates analogously to specific logic circuits.

Certain terms are used throughout the description and claims to refer to particular system components. As one skilled in the art will appreciate, consumer electronic equipment manufacturers may refer to a component by different names. This document does not intend to distinguish between components that differ in name but not function.

Although the invention has been described in terms of preferred embodiment, it is not limited thereto. Those skilled in this technology can make various alterations and modifications without departing from the scope and spirit of the invention. Therefore, the scope of the invention shall be defined and protected by the following claims and their equivalents.

What is claimed is:

1. An apparatus for voice command processing, comprising:
a mobile agent execution platform, comprising:
a native platform;
at least one agent;
a mobile agent execution context providing an application interface, enabling the agent to access resources of the native platform via the application interface; and
a mobile agent management unit performing initiation, running, suspension, resumption and dispatch of the agent,
wherein the agent performs functions regarding voice command processing.

2. The apparatus as claimed in claim 1 wherein the mobile agent management unit is responsible for intercommunicating with the agent, and controls voice command processing.

3. The apparatus as claimed in claim 1 wherein the agent comprises a delegated task, and logic for performing the delegated task.

4. The apparatus as claimed in claim 3 wherein the agent is a speech recognition agent comprising a computer program performing speech recognition, an acoustics model, a lexicon, and a language model, and the computer program processes raw voice data according to the acoustics model, and generates at least one voice word in response to the lexicon and the language model.

5. The apparatus as claimed in claim 4 wherein the speech recognition agent is a clone of a speech recognition of a target device.

6. The apparatus as claimed in claim 4 wherein the mobile agent management unit clones the speech recognition agent, and transmits the cloned speech recognition agent to reside on a mobile agent execution platform of a remote device for executing speech recognition via the remote device.

7. The apparatus as claimed in claim 3 wherein the agent is a language interpretation agent comprising a computer program, a syntax model, and a semantics model, and the computer program acquires a syntax of at least one voice word according to the syntax model, and generates a statement expression by interpreting the acquired syntax according to the semantics model.

8. The apparatus as claimed in claim 7 wherein the language interpretation agent is a clone of a language interpretation agent of a target device.

9. The apparatus as claimed in claim 7 wherein the mobile agent management unit clones the language interpretation agent, and transmits the cloned language interpretation agent to reside on a mobile agent execution platform of a remote device for executing language interpretation via the remote device.

10. The apparatus as claimed in claim 3 wherein the agent is an interpretive representation agent comprising a computer program of interpretive representation, and a plurality of voice commands, and the computer program acquires one of the voice commands in accordance with a statement expression.

11. The apparatus as claimed in claim 10 wherein the interpretive representation agent is a clone of an interpretive representation agent of a target device.

12. The apparatus as claimed in claim 10 wherein the mobile agent management unit clones the interpretive representation agent, and transmits the cloned interpretive representation agent to reside on a mobile agent execution platform of a remote device for executing interpretive representation via the remote device.

13. The apparatus as claimed in claim 1 wherein the mobile agent management unit executes a voice command.

14. A method for voice command processing, performed by an electronic device equipped with a microphone, comprising:
receiving a speech recognition agent comprising a computer program performing speech recognition, an acoustics model, a lexicon, and a language model, the speech recognition agent being a clone of a speech recognition agent of a target device;
receiving raw voice data via the microphone; and
processing the raw voice data according to the acoustics model, and generating at least one voice word in response to the lexicon and the language model by using the speech recognition agent.

15. The method as claimed in claim 14 wherein the electronic device comprises:
a mobile agent execution platform, comprising:
a native platform;
a mobile agent execution context providing an application interface, enabling the speech recognition agent to access resources of the native platform via the application interface; and
a mobile agent management unit performing initiation, running, suspension, resumption and dispatch of the speech recognition agent.

16. The method as claimed in claim 14 further comprising:
receiving a language interpretation agent comprising a computer program performing language interpretation, a syntax model, and a semantics model, the language interpretation agent being a clone of a speech recognition agent of a target device; and
acquiring a syntax of at least one voice word according to the syntax model, and generating a statement expression by interpreting the acquired syntax according to the semantics model by using the language interpretation agent.

17. The method as claimed in claim 14 further comprising:
receiving an interpretive representation agent comprising a computer program performing interpretive representation, and a plurality of voice commands, the interpretive representation agent being a clone of a speech recognition agent of a target device; and
acquiring one of the voice commands in accordance with a statement expression by using the interpretive representation agent.

18. The method as claimed in claim 17 further comprising transmitting the acquired voice command to the target device.

19. An electronic device comprising:
an input device for inputting raw voice data;
a voice command controller recognizing the raw voice data, and comprising a speech recognition agent, a language interpretation agent, and a interpretive representation agent; and
an authentication code,
wherein, when the electronic device connects to a remote device, the voice command controller selectively refreshes the speech recognition agent, the language interpretation agent, and the interpretive representation agent according to the authentication code.

20. The electronic device as claimed in claim 19 wherein the voice command controller sequentially refreshes the speech recognition agent, the language interpretation agent, and the interpretive representation agent.
